(19) United States
(12) Patent Application Publication
(10) Pub. No.: US 2014/0337547 A1
(43) Pub. Date: Nov. 13, 2014

(54) HIGH SPEED DATA TRANSMISSION STRUCTURE

(71) Applicant: Integrated Circuit Solution Inc., Hsin-Chu (TW)

(72) Inventors: CHUNG-CHENG WU, HSIN-CHU (TW); CHUN-LUNG KUO, HSIN-CHU (TW); CHING-TANG WU, HSIN-CHU (TW); CHING-HUNG CHANG, HSIN-CHU (TW); YU-SHEN HSIEH, HSIN-CHU (TW); CHIA-WEI HO, HSIN-CHU (TW)

(73) Assignee: Integrated Circuit Solution Inc., Hsin-Chu (TW)

(21) Appl. No.: 13/943,851

(22) Filed: Jul. 17, 2013

(30) Foreign Application Priority Data
May 10, 2013 (TW) 102116703

(51) Int. Cl. G06F 13/42

(52) U.S. Cl. CPC G06F 13/42
USPC 710/106

(57) ABSTRACT

A high-speed data transmission structure includes first and second electronic units and an input/output bus. The input/output bus is electrically connected to the first and second electronic units, and includes a clock signal line and N data lines, where N is an even integer. The data lines are divided into first and second data signal line groups, each provided with the same number of data lines. In a transmit mode, the first electronic unit generates and transmits a clock signal to the clock data line, and generates output signals at each clock period of the clock signal. The output signals consist of N/2 data signals lasting for two clock periods of the clock signal, and the first and second data signal line groups alternatively receive the output signals. The second electronic unit simultaneously performs a receive mode to fetch and latch the data signals according to the clock signal.

### CROSS-REFERENCE TO RELATED APPLICATION

This application claims the priority of Taiwanese patent application No. 102116703, filed on May 10, 2013, which is incorporated herewith by reference.

### BACKGROUND OF THE INVENTION

1. Field of the Invention

The present invention generally relates to a high speed data transmission structure, more specifically to a structure for high speed data transmission doubling the signal response time and doubling the utility rate of the input/output bus.

2. The Prior Arts

With remarkable advances in the semiconductor industry in recent years, the general electronic devices have provided more versatile and optimal functions by using many high performance electronic elements, especially integrated circuits (ICs), such as processors, controllers, memory modules, power management chips, drivers, sensors, and Micro Electro Mechanical Systems (MEMS). In order to integrate and coordinate these electronic elements to perform high quality and complicated functions, it needs certain suitable transfer interfaces among them to perform data or information transfer, like RS232, Peripheral Component Interconnect (PCI) bus, Universal Serial Bus (USB), Inter-Integrated Circuit (I2C).

For instance, in a PC (personal computer), the central processing unit (CPU) utilizes the high speed interface to access the data in the memories, or employs USB bus to control the external USB devices, such as USB disk drives or USB printers. Additionally, the PC may use the Ethernet interface to connect with the remote web servers so as to perform website surfing or on-line business transaction. In particular, the clock signal and data signals are often used to build up a simple input/output bus, and meanwhile a suitable transfer protocol is included to achieve bidirectional transfer for commands and data such that the electronic elements or devices can communicate with each other and are well coordinated.

Referring to FIG. 1, the first and second electronic units 10 and 20 are connected through the input/output bus (IOB). Also as shown in FIG. 2, the function of data transfer is clearly illustrated by the signal waveform (such as burst length of 4) of the IOB. The IOB may generally include the clock signal TCK and four data signals IO0˜IO3 to implement the operation of double data rate. Therefore, two data of 4 bits length can be continuously transmitted, that is, the first command data including CMD1-D[0]˜CMD1-D[3] for the first command CMD1, and the second command data including CMD2-D[0]˜CMD2-D[3] for the second command CMD2. Specifically, it takes 2 clock periods of the clock signal TCK for each command data to transfer. The second command data is thus transferred after 2 clock periods when the transmission of the first command data is completed. That is, two successive command data are separated by 2 clock periods such that the utility of the IOB is 100% without any waste.

If the IOB is operated under a burst length of 2 as shown in FIG. 3, only two data signals (like IO0 and IO1) of the IOB are used and the remaining two data signals (like IO2 and IO3) are idle. Since it takes only one clock period for each data, the same data transfer rate is attained. However, as the data transfer rate becomes much faster to meet the requirement of the actual application, the clock signal TCK needs to be as fast as possible. As a result, it is possible for the response time of the data signal to be insufficient. The setup time of the data signal, for example, is not fast enough with respect to the clock signal TCK, or the hold time not sustaining long enough. In particular, the utility of the IOB bus is very low, only 50%, that is, 50% of the IOB is idle.

Therefore, it greatly needs to provide a high speed data transmission structure, which can accelerate data transfer rate under the traditional input/output bus by use of modified data transfer scheme, thereby overcoming the above problems in the prior arts.

### SUMMARY OF THE INVENTION

A primary objective of the present invention is to provide a high speed data transmission structure with first and second electronic units and an input/output bus electrically connected to the first and second electronic units. The input/output bus generally consists of a clock signal line and N data lines, where N is an even integer. The N data lines are divided into first and second data signal line groups, each provided with the same number of data lines, that is, N/2. The first electronic unit at least includes the first controller, and the second electronic unit at least includes the second controller. The first and second controllers are used to respectively control the input/output bus to perform different operations, including the transmit mode and the receive mode, thereby implementing data transfer between the first and second electronic units.

For example, the first and second controller perform the transmit mode and the receive mode, respectively. The first controller continuously generates and transmits the clock signal to the clock signal line, and generates the output data at each clock period of the clock signal. The output data includes N/2 data signals and is alternatively transmitted to the first and second data signal line groups according the clock signal. Each data signal lasts for two clock periods. At the same time, the second controller receives the clock signal and the data signals from the first electronic unit, and further fetches and latches the data signals according to the clock signal.

Therefore, the present invention can increase the utility of the input/output bus up to 100% and double the response time of the data signals so as to solve the problem that the response time is insufficient at high speed operation.

### BRIEF DESCRIPTION OF THE DRAWINGS

The present invention can be understood in more detail by reading the subsequent detailed description in conjunction with the examples and references made to the accompanying drawings, wherein:

FIG. 1 is a view showing a system architecture used for data transmission in the prior arts;

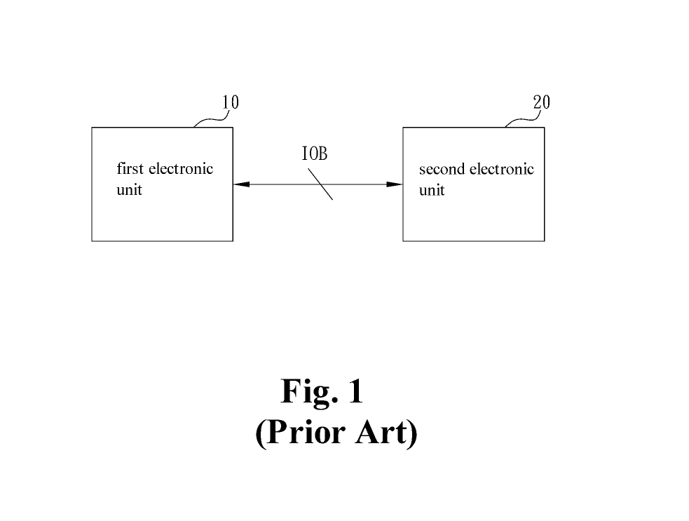

FIG. 2 is a view showing a waveform of data transmission in the prior arts;

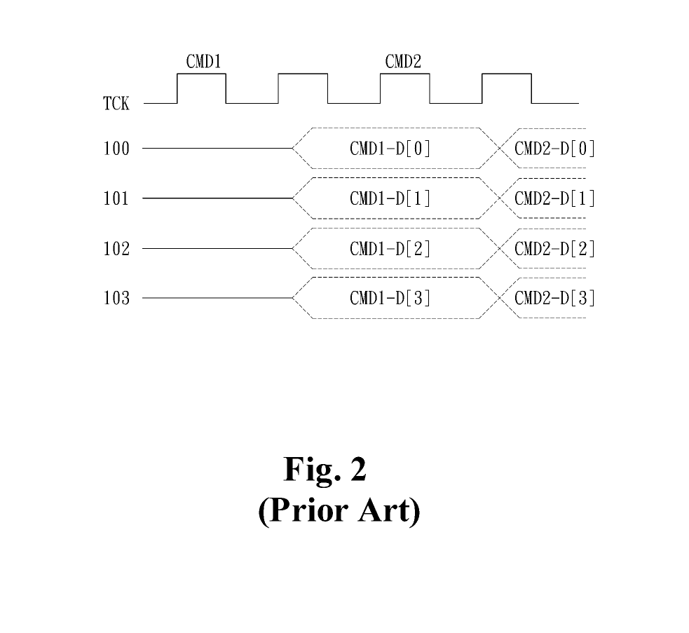

FIG. 3 is a view showing another waveform of data transmission in the prior arts;

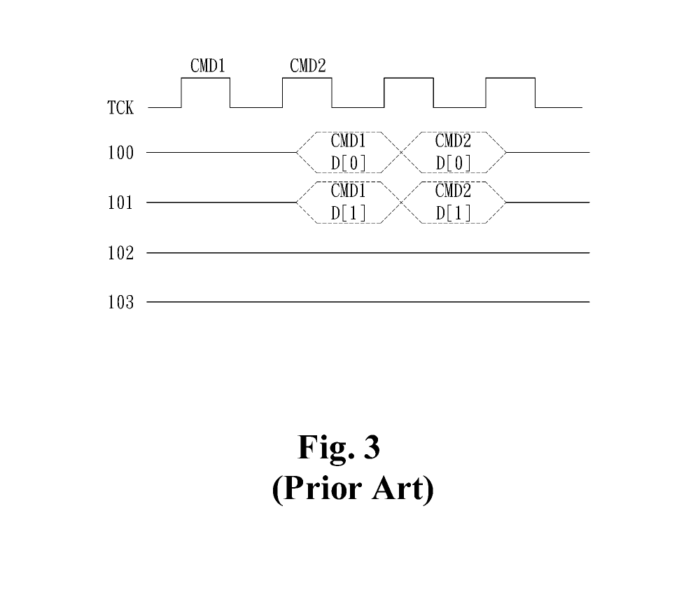

FIG. 4 is a schematic view showing a high speed data transmission structure according to the present invention;

FIG. 5 is a view showing a waveform of data transmission in the high speed data transmission structure according to the present invention; and

FIG. 6 is a schematic view showing one exemplary operation of the high speed data transmission structure according to the present invention.

### DETAILED DESCRIPTION OF THE PREFERRED EMBODIMENTS

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

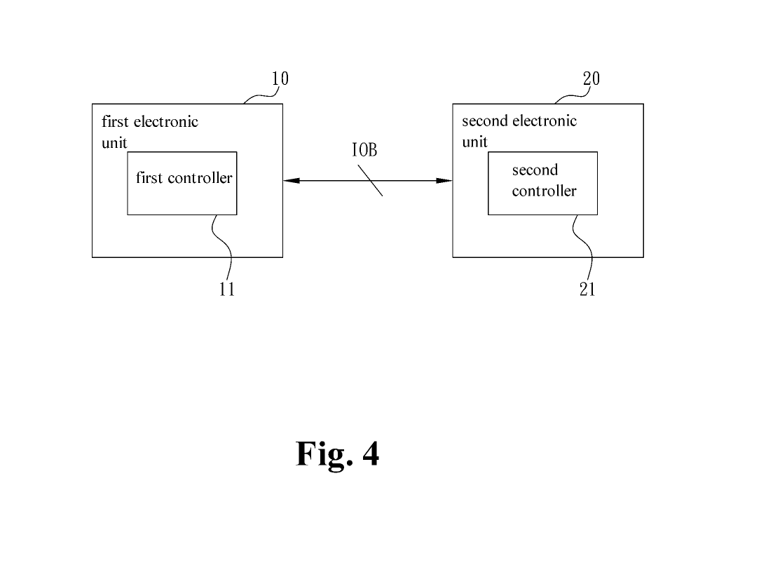

FIG. 4 shows the high speed data transmission structure according to the present invention. As shown in FIG. 4, the high speed data transmission structure of the present invention generally includes a first electronic unit 10, a second electronic unit 20 and an input/output bus IOB, which is electrically connected to the first and second electronic units 10 and 20 for providing data transfer interface.

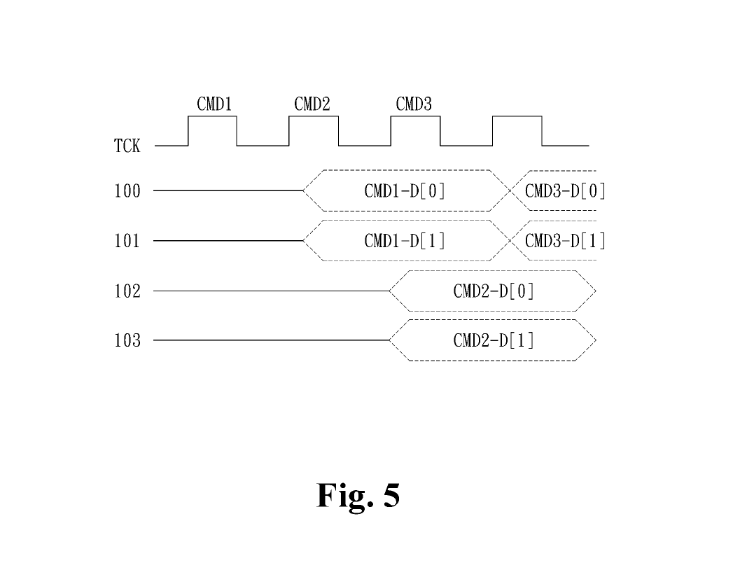

Specifically, the waveform of the signals in the high speed data transmission structure is shown in FIG. 5. The input/output bus JOB preferably at least includes a clock signal line for transmitting a clock signal TCK and N data lines for transmitting N data signals (like the first, second, third and fourth signals IO0˜IO3), where N=4 in the present embodiment, that is, the first, second, third and fourth signal lines. However, it should be noted that the present embodiment is only intended to illustrate the primary features of the present invention, and not limit the scope of the present invention. In other words, N can be any even integer. The N data lines are divided into first and second data signal line groups, each group provided with the same number of data lines, that is, N/2. For instance, the first data signal line group may include the first and second signal lines, and the second data signal line group may include the third and fourth signal lines.

Additionally, the first electronic unit 10 at least includes a first controller 11, and the second electronic unit 20 at least includes a second controller 21. The first and second controllers 11 and 21 are used to respectively control the input/output bus IOB to perform different operations of data transmission, including the transmit mode and the receive mode, so as to implement the data transfer operation between the first and second electronic unit 10 and 20. The first and second controllers 11 and 21 can be controlled by the MCU (microcontroller) which performs via specific firmware.

To clearly explain the operation of the present invention in the following description, the first and second controllers 11 and 21 are specified to perform the transmit mode and the receive mode, respectively. In other words, the first electronic unit 10 transmits data to the second electronic unit 20.

In the transmit mode, the first controller 11 continuously generates and transmits the clock signal TCK to the clock signal line of the input/output bus IOB. Meanwhile, the first controller 11 further generates the output data containing N/2 data signals at each clock period of the clock signal TCK, and the output data is continuously and alternatively transmitted to the first and second data signal line groups according to the clock signal TCK.

At the same time, the second controller 21 performs the receive mode by using the input/output bus IOB to receive the clock signal TCK from the first controller 11 and the output data on the first and second data signal line groups (each having N/2 data signals), and fetch and latch the output data according to the clock signal TCK.

Since each data signal transmitted by the first controller 11 lasts for 2 clock periods of the clock signal TCK, the output data continuously transmitted is transferred to the second controller 21 at each clock period through the first and second data signal line groups, alternatively.

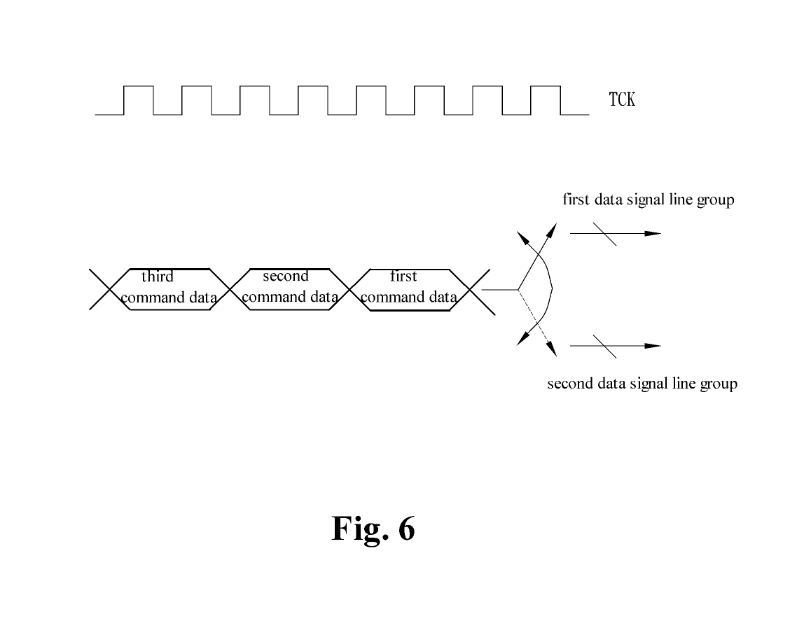

For instance, FIG. 5 shows the waveform of data transmission in the high speed data transmission structure according to the present invention. After the successive first, second and third commands CMD1, CMD2 and CMD3 separated by one clock period of the clock signal TCK are sent off, the first controller 11 transfers the first command data CMD1-D[0]˜CMD1-D[1] to the first data signal line group corresponding to the first command CMD1 served as IO0 and IO1, the second command data CMD2-D[0]˜CMD2-D[1] corresponding to the second command CMD2 is subsequently transferred to the second data signal line group at the next clock period as IO2 and IO3, and then the third command data CMD3-D[0]˜CMD3-D[1] corresponding to the third command CMD3 is transferred to the first data signal line group as IO0 and IO1 at the further next clock period. Thus, by repeating the above-mentioned processes, several output data can be continuously transmitted, as shown in FIG. 6.

For the second electronic unit 20 performing the receive mode, the second controller 21 first fetches the data signals of the first data signal line group, then the data signals of the second data signal line group, and next the data signals of the first data signal line group. Similarly, by repeating the above-mentioned processes, the data signals of the first and second data signal line groups are alternatively fetched. In particular, each of the data signals holds for 2 clock periods of the clock signal TCK so as to improve the reliability of the data fetch operation for the second electronic unit 20, thereby decreasing the difficulties of the operation. In other words, the second electronic unit 20 can fetch the data signals within 2 clock periods of the clock signal TCK.

Therefore, it is obviously noticed from the above description that the primary aspect of the present invention is to utilize the controller included in one electronic unit to perform data transmit operation by alternatively switching the successive output data to the first and second data signal line groups of the input/output bus such that the controller included in another electronic unit can receive the data through the first and second data signal line groups. As a result, the input/output bus is fully employed with up to 100% utility. Meanwhile, the response time of the data signal is doubled, and the problem that the response time of the data signal is insufficient at the high speed data transfer operation, that is, the clock signal TCK being high, is thus overcome.

Although the present invention has been described with reference to the preferred embodiments, it will be understood that the invention is not limited to the details described thereof Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A high speed data transmission structure comprising:
a first electronic unit including at least one first controller for performing a transmission operation, wherein the transmission operation is used to implement one of a transmit mode for transmitting data and a receive mode for receiving the data;
a second electronic unit including at least one second controller for performing another transmission operation, wherein the another transmission operation is used to implement one of the transmit mode and the receive mode, and the another transmission operation is different from the transmission operation; and
an input/output bus electrically connected to the first and second electronic units for providing a data transfer interface,
wherein the input/output bus at least includes a clock signal line for transmitting a clock signal and N data signal lines for respectively transferring N data signals, N is a positive even integer, the N data signal lines are divided into a first and second data signal line groups, each having equal number of data signal lines, the transmission mode includes steps of continuously generating and transferring the clock signal to the clock signal line of the input/output bus, generating an output data at each clock period of the clock signal, each output data including N/2 data signals, and alternatively transferring the output data to the first and second groups of signal lines, and the receive mode includes steps of receiving the clock signal through the input/output bus, alternatively receiving the output data of the first and second groups of signal lines, and fetching and latching the output data according to the clock signal, each data signal lasting for two clock periods of the clock signal.

2. The high speed data transmission structure as claimed in claim 1, wherein the first and second controllers are implemented by respective microcontrollers performing specific and corresponding firmware.
